(19) United States
(12) Patent Application Publication
(10) Pub. No.: US 2003/0088712 A1
(43) Pub. Date: May 8, 2003

(54) Host downloaded multi-segment DSP code file format

(76) Inventor: Thomas A. Schultz, Hillsboro, OR (US)

Correspondence Address: FISH & RICHARDSON, PC, 4350 LA JOLLA VILLAGE DRIVE, SUITE 500, SAN DIEGO, CA, 92122, US

(21) Appl. No.: 10/006,902

(22) Filed: Nov. 8, 2001

(51) Int. Cl. G06F 13/10; G06F 9/00

(52) U.S. Cl. 709/321; 709/327

(57) ABSTRACT

A device driver to download code segments to a processor is provided. The device driver includes a code file including a plurality of code segments having corresponding segment code addresses. A jump table maps each of the segment code addresses to segment identifiers that correspond to the code segment. A loader, in response to a segment request including a segment label, queries the jump table for a segment code address corresponding to the segment identifier. The loader sends a code segment corresponding to the segment label to the processor.

### TECHNICAL FIELD

This invention relates to device drivers for computer systems, and more particularly to device drivers for downloading operating code to a processor.

### BACKGROUND

Computer systems typically include one or more device drivers to allow the operating system of the host system to support certain hardware devices such as a modem, network interface card, printer, and many others. The hardware device may include a processor and local memory to implement the device functions. The device driver may include code that communicates directly to the hardware device and its local memory, to control the operation of the hardware device processor. To reduce the cost of the hardware device, the amount of local memory in a device is typically minimized. However, the amount of local memory generally cannot be reduced to less than what is required for storing the downloaded instructions from the device driver. Therefore, it is desirable to reduce the quantity of downloaded instructions that are stored in the local memory of a hardware device.

### DESCRIPTION OF DRAWINGS

FIG. 1 is a block diagram of a driver coupled to a DSP.

FIG. 2 is a diagram of a jump table.

FIG. 3 is a flow diagram of a device driver download to a processor.

Like reference symbols in the various drawings indicate like elements.

### DETAILED DESCRIPTION

FIG. 1 shows a device driver 10 for downloading multi-segment code to a digital signal processor (DSP) 12 upon request. The DSP 12 includes a limited amount of local memory 13 in which downloaded code segments may be stored. The device driver 10 includes a code file 14 that is loaded into host memory. The code file 14 contains firmware code 16 for controlling the DSP 12. The firmware code 16 includes separate code segments 22 with corresponding segment code addresses 24 that may be used to locate the code segments 22 in memory. Each of the code segments 22 may include one or more instruction codes for controlling the operation of the DSP 12 during different operating modes. For example, when the DSP 12 is switched from a sensing mode of operation to an outputting mode, a code segment 22 that includes the operating instructions for the outputting mode may be requested by the DSP 12 from the driver 10. By switching in code segments only when needed, the DSP 12 minimizes the quantity of local memory 13 that is required, thereby reducing the cost of the interface assembly.

The code file 14 may also include a description 18 of the firmware code 16 as well as build information 20. The code description 18 is in human readable format to enhance understanding of the operation of the firmware code 16. The build information 20 is also human readable to improve maintenance and upgradability of the code file 14.

A jump table 26 maps segment labels to the address locations of the code segments 22 through a mechanism such as an array of memory pointers. The segment labels may be any combination of characters such as a numeric or alpha-numeric. Each segment label identifies an absolute address corresponding to a code segment 22. By mapping segment labels to the absolute address of the code segments 22, the DSP 12 can request a code segment 22 without knowledge of the absolute address at which the code segment 22 is located. The address location of a code segment 22 may be described by the starting address of the code segment 22, the ending address of the code segment 22 in combination with the segment size, and all other means of identifying the absolute address of the code segment 22.

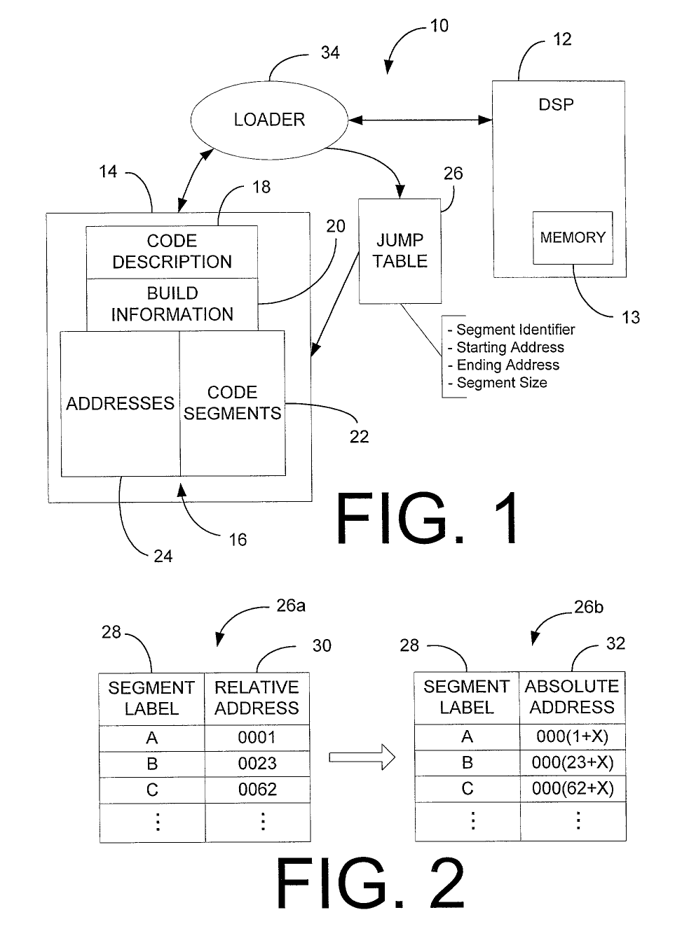

FIG. 2 shows the formation of the jump table 26. Initially, the jump table 26a is created with segment labels 28 that are mapped to the relative addresses 30 of the code segments 22. Each of the code segment relative addresses 30 describes the location of a code segment 22 in relation to the other code segments 22. When the absolute addresses 32 of the code segments 22 are determined, the relative addresses 30 may be fixed-up to reflect the absolute addresses 32 for the code segments 22. The absolute addresses 32 may be determined once a location in memory has been allocated for the code file 14, or after the code file 14 is loaded into memory by using a conversion factor. For example, if the code file 14 is sequentially loaded into memory, the address offset of the code file 14 in memory may be used as the conversion factor for fixing-up the relative addresses. The offset may be used as a constant by which each of the relative addresses 30 is incremented so that the jump table 26b includes the absolute addresses 32 of the code segments 22. By overwriting the relative addresses 30 with the absolute addresses 32, the computation speed of the driver 10 is increased and the amount of memory used is reduced. Instead of overwriting the relative addresses 30, the offset may be stored and then used in combination with the relative addresses 30 to compute the absolute addresses 32 when a code segment 22 is downloaded. Also, the relative addresses 30 may be retained in addition to the absolute addresses 32.

A loader 34 loads the code file 14 and jump table 26 into memory. The loader 34 may also receive and respond to download requests from the DSP 12 for code segments 22. The download requests identify the requested code segment 22 by a corresponding segment label 28. In response, the loader 34 locates the requested code segment 22, and then sends the code segment 22 to the DSP 12.

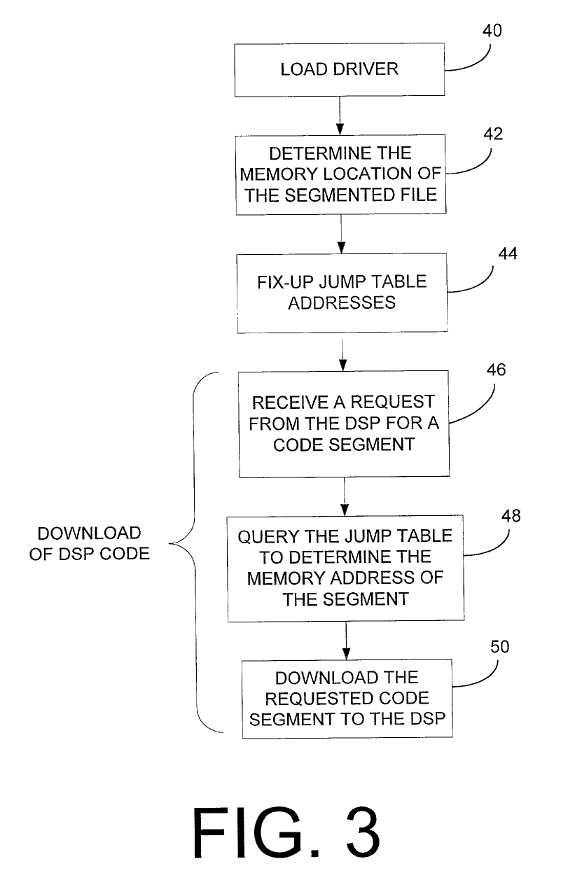

FIG. 3 shows a process for downloading a code segment 22 to the DSP 12. Beginning at state 40, the driver 10 is loaded into the memory of a host computer system. A form of bootstrapping operation may be used to load the device driver 10 into memory. First, the loader 34 is loaded into memory. Then, the loader 34 loads the code file 14 and jump table 26 into the host memory. The loader 34 also supports dynamic download of a revised code file 14. For example, if the code file 14 and jump table 26 have been previously loaded into host memory, the loader 34 may load a revised code file 14 and jump table 26 into host memory so that a dynamic download to the DSP 12 may be performed without resetting the host computer. Continuing on to state 42, the loader 34 determines the memory location of the loaded code file 14. At state 44, the conversion factor is determined for generating absolute addresses 32 corresponding to the relative addresses 30 in the jump table 26. The conversion factor is used to fix-up the relative addresses 30 in the jump table 26 so that absolute address references 32 are created.

Continuing on to states 46 to 50, a dynamic download operating phase of the driver 10 is shown. Once the driver 10 is loaded into the host system memory (not shown), the driver is ready to download code segments 22 to the DSP 12. At state 46, a download request from the DSP 12 is received. The download request identifies a requested code segment 22 by a corresponding segment label 28. Continuing on to state 48, the jump table 26b is queried to determine the segment code address 32 of the identified code segment 22. At state 50, the code segment 22 is then downloaded from the referenced location in the host memory to the DSP 12.

A number of embodiments of the invention have been described. Nevertheless, it will be understood that various modifications may be made without departing from the spirit and scope of the invention. Accordingly, other embodiments are within the scope of the following claims.

What is claimed is:

1. A device driver comprising:
a code file including a plurality of code segments having corresponding segment code addresses;
a jump table to map segment labels to the segment code addresses, the segment labels to identify the code segments; and
a loader, in response to a segment request including a segment label, to query the jump table for a segment code address corresponding to the segment label, and to send a code segment corresponding to the segment label.

2. The device driver of claim 1 wherein the code file further includes a human readable description.

3. The device driver of claim 1 wherein the code file further includes build information.

4. The device driver of claim 1 wherein the jump file further includes relative segment addresses that are overwritten by the segment code addresses.

5. The device driver of claim 1 wherein the segment code address includes a segment start address.

6. The device driver of claim 5 wherein the segment code address further includes a segment end address and a segment size.

7. The device driver of claim 1 wherein the loader loads the code file and the jump table into a host memory.

8. A method comprising:
receiving a download request from a processor for a code segment;
querying a jump table to determine a segment code address corresponding to the code segment; and
downloading the code segment to the processor.

9. The method of claim 8 further comprising using a segment label to identify the code segment.

10. The method of claim 9 further comprising using the jump table to map the segment label to the segment code address.

11. The method of claim 10 further comprising initially loading the jump table with relative code segment addresses; and
computing segment code addresses as a function of the relative code segment addresses and a conversion factor.

12. The method of claim 11 wherein computing includes adding an offset to each of the relative code segment addresses; and
overwriting the relative code segment addresses with the segment code addresses.

13. A device driver comprising:
a loader to load a code file and a jump table into host memory;
the code file including at least two code segments, each code segment having a segment code address;
the jump table to map each segment code address to segment labels corresponding to the code segments;
the loader, in response to a segment request including a segment label, to query the jump table for the segment code address corresponding to the segment label, and to send a code segment corresponding to the segment label.

14. The device driver of claim 13 wherein the jump file further includes relative segment addresses that are overwritten by the segment code addresses.

15. The device driver of claim 13 wherein the segment code address includes a segment start address.

16. The device driver of claim 13 wherein the segment code address further includes a segment end address and a segment size.

17. A machine accessible medium which when accessed results in a machine performing operations comprising:
receiving a download request from a processor for a code segment;
querying a jump table to determine a segment code address corresponding to the code segment; and
downloading the code segment to the processor.

18. The machine accessible medium of claim 17 which when accessed results in a machine performing operations further comprising identifying the code segment with a segment label.

19. The machine accessible medium of claim 17 wherein the jump table maps the segment identifier to the segment code address.

20. The machine accessible medium of claim 19 which when accessed results in a machine performing operations further including:
initially loading the jump table with relative code segment addresses; and
computing segment code addresses as a function of the relative code segment addresses and a conversion factor.

21. A machine readable medium including machine readable instructions that when executed by a machine, cause the machine to:
receive a download request from a processor for a code segment;
query a jump table to determine a segment code address corresponding to the code segment; and
download the code segment to the processor.

22. The machine readable medium of claim 21 further including machine readable instructions that when executed by a machine, cause the machine to identify the code segment with a segment label.

23. The machine readable medium of claim 21 wherein the jump table maps the segment identifier to the segment code address.

24. The machine readable medium of claim 23 further including machine readable instructions that when executed by a machine, cause the machine to:
initially load the jump table with relative code segment addresses; and
compute segment code addresses as a function of the relative code segment addresses and a conversion factor.
